(19) United States
(12) Patent Application Publication
(10) Pub. No.: US 2015/0045101 A1
(43) Pub. Date: Feb. 12, 2015

(54) Texas Hold'em Style Poker Game and Method Therefor

(71) Applicant: Tony Patelidas, Las Vegas, NY (US)

(72) Inventor: Tony Patelidas, Las Vegas, NY (US)

(21) Appl. No.: 13/960,079

(22) Filed: Aug. 6, 2013

(51) Int. Cl. A63F 13/45

(52) U.S. Cl. CPC A63F 13/45
USPC 463/13

(57) ABSTRACT

A method of playing a poker-type card game comprising: dealing a first player card to each player; displaying first, second and third community cards; posting of blinds; dealing a second player card to each player; displaying a fourth community card; and displaying a fifth community card.

### TECHNICAL FIELD

This invention relates generally to card games and methods therefor and, more particularly, to a Texas Hold'em style poker game that allows for an initial viewing of the playing cards before the betting rounds.

### BACKGROUND

The card game of poker, with its many variations, has become an extremely popular form of entertainment. Poker is now a common social pastime for both gamblers and non-gamblers. The general aim of poker is to either collect a five card hand that is better than the five card hand of one or more opponents, or to try to bet in such a way as to cause opponents to believe that their hand is inferior and subsequently “fold” (concede or turn in) their hand. Typically the game of poker involves several players competing against one another for one cumulative “pot” or sum of money. In casinos, the dealer or “house” draws a percentage, otherwise known as “the rake”, of each pot, thus generating revenue regardless of which player wins each hand.

One of the most popular poker games is Texas Hold'em. In Texas Hold'em, each player receives an initial hand of two cards. Typically, there is a betting round followed by the dealing of three community cards face-up, known as “the flop.” After another betting round, a fourth community card, known as “the turn” is dealt face-up. After yet another round of betting, the final community card, known as “the river” is dealt face-up. After the river, there is a final round of betting, assuming two or more players remain in the game. In Texas Hold'em, a player can use any combination of the two initial cards dealt to each player and the five community cards to form the best five-card poker hand. In fact, in Texas Hold'em, it can be possible to use neither of the two cards dealt to the player, and form a best five-card hand solely from the five community cards.

There are different variations of Texas Hold'em being played. Most of these different versions still implement the same basic steps described above. While Texas Hold'em and its different variations offer separate, and intriguing benefits to poker players, each of these games still has certain limitations regarding betting that may make it less intriguing to different types of poker players.

Therefore, it would be desirable to provide a system and method that overcomes the above.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

A computer implemented poker card game, the computer comprising a visual display device and a processor operably coupled to the display device and combined to display a card game, the processor programmed for a method comprising: dealing a first player card to each player; displaying first, second and third community cards; posting of blinds; dealing a second player card to each player; displaying a fourth community card; and displaying a fifth community card.

A method of playing a poker-type card game comprising: dealing a first player card to each player; displaying first, second and third community cards; posting of blinds; dealing a second player card to each player; displaying a fourth community card; and displaying a fifth community card.

The features, functions, and advantages may be achieved independently in various embodiments of the disclosure or may be combined in yet other embodiments.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a poker table for implementing the present invention;

FIG. 2 is a flow chart showing a method of playing the poker game of the present invention; and

FIG. 3 is a block diagram showing a computer system which may he used to implement the poker game of the present invention.

### DESCRIPTION OF THE APPLICATION

The description set forth below in connection with the appended drawings is intended as a description of presently preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application.

The present application generally relates to an improved poker game, and more; particularly, to a poker-type card game that provides players with the option to view certain playing cards for the current playing hand before the betting rounds. In one embodiment, a card table, known to those skilled in the art, can be used for this poker-type card game. Alternatively, the poker game may be played on a video gaming machine, computer, tablet, smart phone, or the like, The listing of the different types of electronic devices for playing the poker game of the present invention is given as an example and should not be seen in a limiting manner.

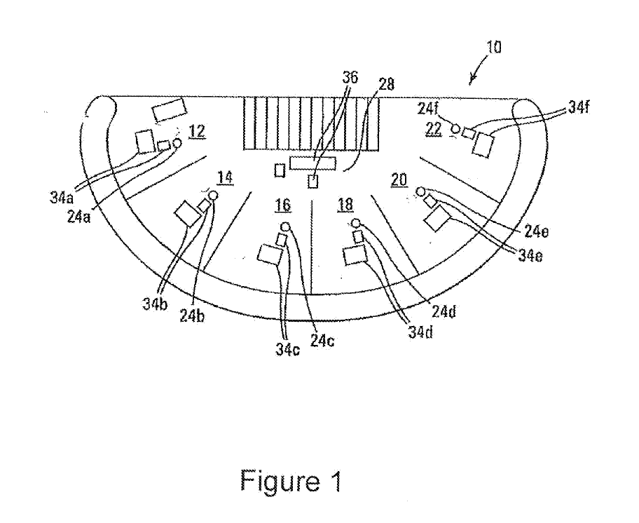

As shown in FIG. 1, a card table 10 (hereinafter table 10) for playing the poker game of the present invention is shown. The table 10 may be designed to have multiple designated player spots 12, 14, 16, 18, 20 and 22, In the present embodiment, 6 player spots are shown. While 6 player spots are shown, this is only shown as an example and should not be seen in a limiting manner. The table 10 may further have a dealer position 28.

The table 10 can include a wagering area for each designated player spot. In the present embodiment, player spot 12 has a wagering area 24a, player spot 14 has a wagering area 24b, player spot 16 has a wagering area 24c, player spot 18 has wagering area 24d, player spot 20 has wagering area 24e, and player spot 22 has wagering area 24f. Other wagering areas 26a 26f may also be provided if desired.

The table 10 may also include a designated card spot for each designated player. In the present embodiment, player spot 12 has a card spot 34a, player spot 14 has a card spot 34b, player spot 16 has a card spot 34c, player spot 18 has a card spot 34d, player spot 20 has a card spot 34e, and player spot 22 has a card spot 34f. Also incorporated within the table 10 can be a community card area 36.

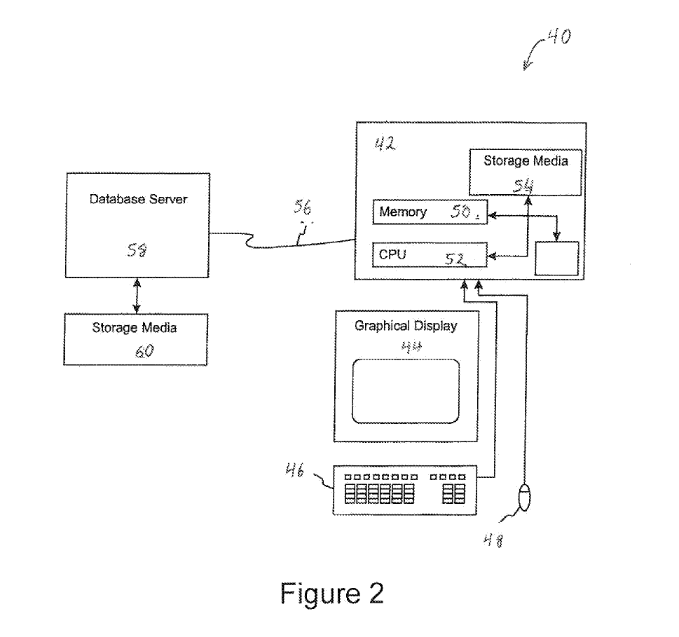

Alternatively, as shown in FIG. 2, the poker game may be played on a computer system 40. The computer system 40 may be a video gaming machine, computer, tablet, smart phone, or the like. The listing of the different types of electronic devices for playing the poker game of the present invention is given as an example and should not be seen in a limiting manner.

The computer system 40 may have a processor unit 42 and a display 44. Input devices may be coupled to the processor unit 42. The input devices may be a keyboard 46, a mouse 48 and the like. The above listing is given as an example. Other type of input devices may be used without departing from the spirit and scope of the present invention. Through the execution of program instructions forming a computer program product within the computer system 40, the computer system 40 will provide the poker type card game of the present invention.

The program instructions may be located within a memory 50 of the processor unit 42 and executed by a central processing unit 52 (CPU). Any data stored from the running of the program instructions may be stored entirely within a storage media 54 and/or the memory 50.

Alternatively, the computer system 40 may have a connection 56 to a network such as a local-area network (LAN), wide-area network (WAN) or the Internet. The connection 56 may be a wired connection, a wireless connection, or the like. In a network implementation, the program instructions may be located within a database server 58. Any data stored may be stored in a storage media 60 coupled to the database server 58.

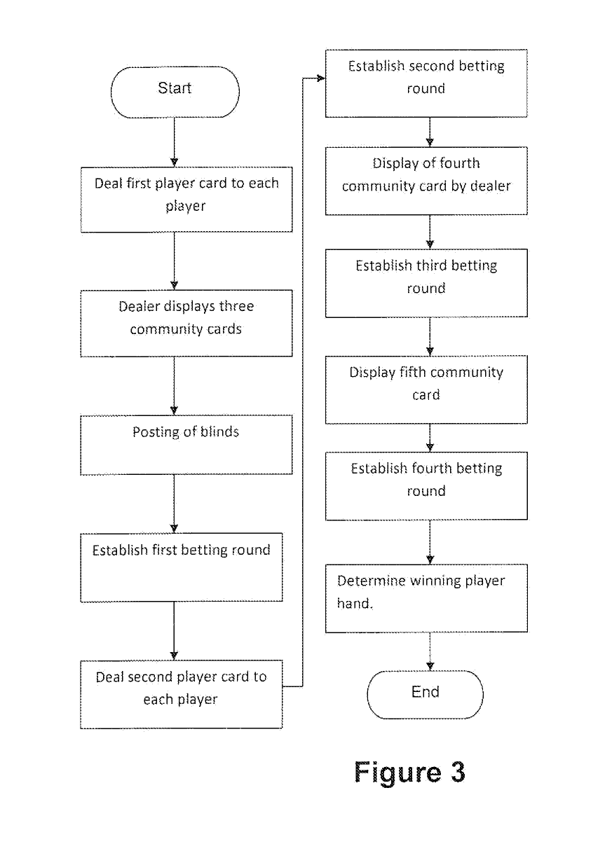

Referring now to FIG. 3, a method of playing the poker game of the present invention will be disclosed, Known to those skilled in the relevant art, the game can be implemented on a number of different platforms such as the table 10, computer 40, or other casino-type machine. The game may also he played as an interactive video game wherein the computer acts as a dealer and players log in to play. The players may be located remotely or all at a video game table. Alternatively, the game can be played as a “video” poker game in which there is only a single player against the machine, or the “house”.

The poker game may be played with a minimum of two players and usually up to a maximum of ten players. A standard 52-card deck may be used, wherein the deck contains thirteen cards, 2, 3, 4, 5, 6, 7, 8, 9, 10, Jack, Queen, King and Ace, each having four suits, Clubs, Diamonds, Hearts and Spades. The deck is generally shuffled before each hand.

Each player can be given a first card. In general, the first card dealt to the each player is dealt face down. Next, the dealer may deal and display the first three community cards, commonly referred to as the ‘flop’. Thus, unlike prior art poker games, the posting of blinds is done after the flop.

Next, is the posting of the blinds. The blinds are automatic bets that have to be made in every single hand of a poker game. In general, the player to the left of the dealer will post the first blind. However, other players may be designated as the player to post the first blind. In general, the first blind may be called the small blind. The small blind may be the minimum bet limit allowed. Thus, for example, if the minimum bet for the table/video game is $5.00, the first blind would generally be $5.00. However, other amounts may be designated as the first blind without departing from the spirit and scope of the present invention.

After the first blind is posted, a second blind is posted. In general, the player to the left of the player who posted the first blind will post the second blind. However, other players may be designated as player to post the second blind without departing from the spirit and scope of the present invention. In general, the second blind may be called the big blind. The big blind may he twice the amount of the small blind. Thus, in the example above, if the minimum bet for the table/video game is $5.00, the second blind would generally be $10.00. However, other amounts may be designated as the second blind without departing from the spirit and scope of the present invention.

After the first and second blinds have been posted, a first betting round begins. Each remaining player may check, bet. call, raise, re-raise (re-raises may be limited to three in any round) or fold. In general, the first player to the left of the player who made the second blind will begin the first betting round. However, other players may be designated as player to begin the first betting round without departing from the spirit and scope of the present invention. Betting continues in a clockwise motion around the table 10. The first betting round ends when no more bets or raises can be made that have not been called or responded to by an all-in or fold.

After the first betting round, a second player card is dealt to each remaining player who has not folded. The second player card is generally dealt face down. Once each remaining player has received their second playing card, a second betting round begins. The second betting round may begin with the player who posted the first blind. However, other remaining players may be designated to begin the second round. If the player who posted the first blind has folded, betting will begin in a clockwise motion with the first player remaining. Each remaining player may check, bet, call, raise, re-raise (re -raises may be limited to three in any round) or fold. The second betting round ends when no more bets or raises can be made that have not been called or responded to by an all-in or fold.

Next, a fourth community card (the “turn”) is then dealt and displayed by the dealer After the fourth community card is dealt and displayed, a third betting round may begin. In general, the third betting round may begin with the player who posted the first blind, However, other remaining players may be designated to begin the third betting round. If the player who posted the first blind has folded, betting will begin in a clockwise motion with the first player remaining, Each remaining player may check, bet, call, raise, re-raise (re-raises may be limited to three in any round) or fold. The third betting round ends when no more bets or raises can be made that have not been called or responded to by an all-in or fold.

Next, a fifth community card (the ‘river’) is dealt and displayed by the dealer. After the fifth community card is dealt and displayed, a fourth and final betting round may begin. In general, the fourth and final betting round may begin with the player who posted the first blind. However, other remaining players may be designated to begin the fourth and final betting round, If the player who posted the first blind has folded, betting will begin in a clockwise motion with the first player remaining. Each remaining player may check, bet, call, raise, re-raise (re-raises may be limited to three in any round) or fold. The fourth and final betting round ends when no more bets or raises can be made that have not been called or responded to by an all-in or fold.

After the fourth and final betting round, the last bettor's cards are opened and ‘read’ to determine the strength of that hand when combined with the five community cards. The same reading of hands is done in clockwise order with respect to each remaining player's cards. The winner(s) are declared and the pot is distributed. A dealer may make this identification during live play. In a video format, the computer program will automatically select the combination that creates the five-card poker hand having the highest poker value.

The main benefit of the present invention is that each player may look at his/her first player card as well as the first three community cards prior to the blinds being posted. Each player may further receive and review his/her second player as well as the first three community cards prior to the first betting round.

While embodiments of the disclosure have been described in terms of various specific embodiments, those skilled in the art will recognize that the embodiments of the disclosure may be practiced with modifications within the spirit and scope of the claims.

What is claimed is:

1. A computer implemented poker card game, the computer comprising a visual display device and a processor operably coupled to the display device and combined to display a card game, the processor programmed for a method comprising:
dealing a first player card to each player;
displaying first, second and third community cards;
posting of blinds;
dealing a second player card to each player;
displaying a fourth community card; and
displaying a fifth community card.

2. The method of claim 1, further comprising determining a best five-card poker hand for each player, the best five-card poker hand comprising a combination of the first and second player cards for each player and the first, second, third, fourth and fifth community card.

3. The method of claim 1, further comprising establishing a first betting round after posting of the blinds,

4. The method of claim 3, further comprising establishing a second betting round for all remaining players after dealing the second player card to each player.

5. The method of claim 4, further comprising establishing a third betting round for all remaining players after displaying the fourth community card.

6. The method of claim 5, further comprising establishing a fourth betting round for all remaining players after displaying the fifth community card.

7. A method of playing a poker-type card game comprising:
dealing a first player card to each player;
displaying first, second and third community cards;
posting of blinds;
dealing a second player card to each player;
displaying a fourth community card; and
displaying a fifth community card.

8. The method of claim 7, further comprising determining a best five-card poker hand for each player, the best five-card poker hand comprising a combination of the first and second player cards for each player and the first, second, third, fourth and fifth community card.

9. The method of claim 7, further comprising establishing a first betting round after posting of the blinds.

10. The method of claim 9, further comprising establishing a second betting round for all remaining players after dealing the second player card to each player.

11. The method of claim 10, further comprising establishing a third betting round for all remaining players after displaying the fourth community card.

12. The method of claim 11, further comprising establishing a fourth betting round for all remaining players after displaying the fifth community card.

13. A computer implemented poker card game, the computer comprising a visual display device and a processor operably coupled to the display device and combined to display a card game, the processor programmed for a method comprising
dealing a first player card;
displaying flop cards;
posting of blinds;
dealing a second player card;
displaying a turn card; and
displaying a river card.

14. The method of claim 13, further comprising determining a best five-card poker hand for each player, the best five-card poker hand comprising a combination of the first and second player cards for each player and the flop, turn and river cards.

15. The method of claim 13, further comprising establishing a first betting round after posting of the blinds.

16. The method of claim 15, further comprising establishing a second betting round for all remaining players after dealing the second player card to each player.

17. The method of claim 15, further comprising establishing a third betting round for all remaining players after displaying the turn card.

18. The method of claim 17, further comprising establishing a fourth betting round for all remaining players after displaying the river card.
